(19) United States
(12) Patent Application Publication
(10) Pub. No.: US 2005/0003960 A1
(43) Pub. Date: Jan. 6, 2005

(54) Heterogeneous catalyst compositions

(76) Inventors: Erling Rytter, Stavanger (NO); Morten Ronnekleiv, Stavanger (NO)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/495,701

(22) PCT Filed: Nov. 14, 2002
(86) PCT No.: PCT/GB02/05124

(30) Foreign Application Priority Data
Nov. 16, 2001 (GB) 0127517.1

(51) Int. Cl. B01J 23/755

(52) U.S. Cl. 502/335

(57) ABSTRACT

The invention provides a formed heterogeneous catalyst composition comprising a particulate M^{II}(M^{III})O (wherein M^{II} and M^{III} are divalent and trivalent metals respectively) catalyst support and a particulate binder wherein the surface area per unit weight of the support is greater than that of said binder and wherein the compressability of said binder is less than that of said support.

This invention relates to catalysts and catalyst supports and their production and use.

Many chemical reactions are performed using heterogeneous catalysts in which a catalytically active material is supported on a particulate carrier support.

Depending on the reaction to be catalysed, various different demands are placed on the catalytic support material, typically that it should have a high surface area and that it should withstand the conditions of the reaction and of any catalyst regeneration treatment. As a result, high surface area inorganic materials, e.g. metal and pseudometal oxides such as aluminas, magnesium oxides and silicas, are frequently used as catalyst support materials. Such high surface area inorganic support materials may typically take the form of porous particles, microcrystalline aggregates, laminar structures (e.g. clays), etc.

One class of catalyst support material that has been found to be particularly suitable for alkane dehydrogenation reactions comprises the mixed metal oxides M^{II}₁₋ₙM^{III}_{2n/3}O (wherein M^{II} is a divalent metal, e.g. Mg, M^{III} is a trivalent metal, e.g. Al, and n<0.6, preferably <3/7, especially <3/11). For convenience, these mixed metal oxides of formula M^{II}₁₋ₙM^{III}_{2n/3}O are referred herein as M^{II}(M^{III})O. Thus, where the mixed metal oxide is a magnesium aluminium oxide it may be referred to herein as Mg(Al)O. Such M^{II}(M^{III})O compounds may be produced by thermal treatment of anionic clays such as hydrotalcite(-like) clays (HTC). The M^{II}(M^{III})O material produced by thermal treatment of anionic clays is a microcrystalline aggregate and as such is not mechanically robust. Indeed both the M^{II}(M^{III})O materials and the anionic clay precursors are soft powders resembling talcum powder in consistency to the touch.

In the field of heterogeneous catalysis, on the commercial scale it is generally necessary to present the catalyst as a physically robust macrostructure (i.e. having dimensions of 1 mm or greater). Where the catalyst is itself not mechanically robust, this commonly involves depositing the catalyst on a rigid macrostructure support (e.g. a plate or mesh or in a matrix such as cement) or formulating it as a powder with a particulate binder which allows the catalyst composition to be compacted into pellets or the like without unduly damaging the powder particles of the catalyst.

We recently found however that the mechanical strength of heterogeneous catalysts having M^{II}(M^{III})O as the catalyst support was surprisingly increased if an HTC was deposited on θ-alumina or pseudo-boehmite and the resulting composition was calcined to yield an M^{II}(M^{III}))O/alumina material in which the alumina component is more mechanically robust than the M^{II}(M^{III})O component. This is described in WO 01/87773 the content of which is hereby incorporated by reference. We have now found that the use of hard binders other than aluminas also makes the catalyst compositions more mechanically robust.

Over the prolonged lifetime of M^{II}(M^{III})O supported catalysts, spinel (M^{II}(M^{III}₂O₄) formation occurs resulting in a reduction in the surface area and gradual deactivation of the catalyst. (Avoidance of spinel formation is a reason for the upper temperature limit for the calcination treatment by which HTC is transformed to M^{II}(M^{III})O—see WO 99/46039 for example, the contents of which are hereby incorporated by reference).

We have now surprisingly found that the binder material can contribute to this spinel formation and that the spinel formation may be significantly reduced, without compromising the mechanical strength of the catalyst, by the use as a binder of particles of a material which is essentially non-reactive with the support material under the conditions of the catalysed reaction and the catalyst regeneration treatment.

Thus viewed from one aspect the invention provides a formed heterogeneous catalyst composition comprising a particulate M^{II}(M^{III})O (wherein M^{II} and M^{III} are divalent and trivalent metals respectively) catalyst support and a particulate binder wherein the surface area per unit weight of the support is greater than that of said binder and wherein the compressibility of said binder is less than that of said support, with the provisos that where said support carries a catalytically active metal and is the product of calcination of an HTC in the presence of a magnesium or aluminium oxide then said catalytically active metal is loaded onto said support before said support is contacted with said binder and that where said support is M^{II}(M^{III})O wherein the divalent and trivalent metals are nickel and aluminium and which is not impregnated with a catalytically active metal then the binder is other than alumina or zirconia.

As defined above, the invention excludes mixtures of alumina or zirconia and an M^{II}(M^{III})O wherein the divalent and trivalent metals are nickel and aluminium. This exclusion is made since this combination is mentioned in GB-A-1462060. GB-A-1462060 proposes the use of Ni₆Al₂(OH)₁₆CO₃4H₂O as a catalyst precursor and states that this Ni/Al compound may be precipitated on a support. While, as was conventional, soft supports such as hydrated alumina (e.g. boehmite) were stated to be preferred and were utilized in the Examples, the hard supports zirconia and α-alumina were mentioned in the list of possible supports. In any event, it is preferred in the present invention that the support be other than an M^{II}(M^{III})O wherein the divalent metal is nickel and the trivalent metal is aluminium.

By “formed”, it is meant that the composition is shaped into a self supporting form, e.g. a pellet, rod, spheroid, extrudate etc.

The surface area of a particulate may readily be determined by nitrogen adsorption using the BET-method. The compressibility of a particulate may be determined by placing a quantity of the powder in a vertical cylinder, tapping the cylinder to allow the powder to settle, and applying pressure to the powder surface to cause the powder to become compacted. Comparison of the compressibility of two different particulates may be by comparison of the reduction in height on application of the same pressure or by comparison of the different pressures required to produce the same reduction in height, e.g. a reduction of 5, 10 or 20%. For the present invention, the relative compressibility of binder and support is conveniently measured as the ratio of decreases in height of binder to support on application of a load of between 3.75 and 23 kN/cm². In this range, e.g. at 3.75, 5.64, 13.16 or 22.56 kN/cm², for particles in the size range 50-90 μm, the relative compressibility is preferably less than 0.84, more preferably less than 0.77, especially preferably less than 0.69, particularly less than 0.60. At 3.75 kN/cm², the binder preferably has a % compressibility (i.e. 100 (1-(pressed height/original height)) below 30%, especially below 26%, e.g. 15 to 25%. At 22.5 kN/cm², the binder preferably has a % compressibility of below 50%, more preferably below 46%, e.g. 40 to 45%.

The catalyst compositions of these instructions preferably have a high surface area, e.g. at least 20 m²/g, especially 50 to 300m²/g, more especially 100 to 200 m²/g.

The binder in the compositions of the invention is preferably one which does not promote spinel formation in the M^{II}(M^{III})O support during the use of the catalyst. To this end it is preferably a material which does not act as a source of M^{III} atoms compatible with the M^{II}(M^{III})O structure or as an abstractor of M^{II} atoms from the M^{II}(M^{III})O structure. It is therefore preferred that the binder not be an M^{III} compound or if it is that it is an essentially inert compound, e.g. θ or α-alumina, preferably α-alumina.

The catalyst compositions of the invention are especially preferably prepared by thermal treatment (i.e. calcination) of a mixture of an HTC and a binder or a binder precursor. While the resulting M^{II}(M^{III})O support may be loaded with the catalyst after calcination, catalyst loading is preferably effecting during HTC formation or more preferably after HTC formation and before calcination. If desired, the HTC may be produced in a dispersion of the binder or binder precursor; however to minimize catalyst wastage (important since the catalyst is frequently expensive), the binder or the binder precursor is preferably mixed with an HTC which is already catalyst-loaded, e.g. by mixing in a liquid (preferably aqueous) dispersion.

The HTC and binder or binder precursor mixtures and the product of their calcination also form aspects of the invention.

Viewed from a further aspect therefore the invention provides a particulate heterogeneous catalyst composition comprising a particulate, catalyst-carrying, M^{II}(M^{III})O support and a particulate binder wherein the surface area per unit weight of the support is greater than that of said binder and wherein the compressibility of said binder is less than that of said support, with the provisos that where said support carries a catalytically active metal and is the product of calcination of a hydrotalcite(-like) clay (HTC) in the presence of a magnesium or aluminium oxide then said catalytically active metal is loaded onto said support before said support is contacted with said binder and that where said support is an M^{II}(M^{III})O wherein the divalent and trivalent metals are nickel and aluminium and which is not impregnated with a catalytically active metal then the binder is other than alumina or zirconia.

Viewed from a still further aspect the invention also provides a particulate heterogeneous catalyst composition comprising a particulate, catalyst-impregnated HTC support and a particulate binder or binder precursor, which precursor if present is a material transformable into a binder by thermal treatment under conditions which transform said HTC support into a M^{II}(M^{III})O support, said composition being transformable by thermal treatment into a particulate heterogeneous catalyst composition comprising a particulate, catalyst-carrying, M^{II}(M^{III})O support and a particulate binder wherein the surface area per unit weight of the support is greater than that of said binder and wherein the compressibility of said binder is less than that of said support, with the proviso that where said binder or binder precursor is a magnesium or aluminium oxide then said HTC support is loaded with catalyst before being contacted with said binder or binder precursor.

Viewed from a yet still further aspect the invention provides a process for the preparation of a heterogeneous catalyst composition according to the invention, which process comprises:
i) loading a particulate HTC support with a catalytically active metal.
ii) before, during or preferably after step (i), forming a mixture of said HTC support and a particulate binder or binder precursor;
iii) thermally treating said mixture whereby to transform said HTC support into an M^{II}(M^{III})O support and, where a binder precursor is present, to transform said binder precursor into a particulate binder; and, optionally;
iv) forming the thermally treated mixture into a formed heterogeneous catalyst composition.

While the invention is particularly concerned with heterogeneous catalysts containing an M^{II}(M^{III})O catalyst support, it is considered that the concepts involved are applicable to other catalyst systems, i.e. the use of a binder which is harder than the support and the use of a binder that does not exacerbate thermal degradation of a thermally degradable support.

Thus viewed from a further aspect the invention provides a formed heterogeneous catalyst composition comprising a particulate catalytically active substance and a particulate binder wherein the weight ratio of said substance to said binder is in the range 99:1 to 50:50, wherein the surface area per unit weight of the support is greater than that of said binder and wherein the compressibility of said binder is less than that of said support, with the provisos that where said substance is an HTC or M^{II}(M^{III})O wherein the divalent and trivalent metals are magnesium and aluminium and said binder is a magnesium or aluminium oxide then said substance is loaded with a catalytically active metal before being contacted with said binder, and that where said support is an HTC or M^{II}(M^{III})O wherein the divalent and trivalent metals are nickel and aluminium and which is not impregnated with a catalytically active metal then the binder is other than alumina or zirconia.

The binder compounds in the compositions of the invention are preferably oxides, especially group 4b oxides, in particular zirconia, titania or hafnia, more particular zirconia. Other preferred binders include hard aluminas (especially θ and α aluminas, particularly α-alumina), boron nitride, silicon carbide, hard silicas, etc.

The binder may typically be a metal oxide produced by heat treatment of a metal hydroxide or oxide-hydroxide. Thus for example zirconia may be prepared by calcination of Zr(OH)₄ and α-alumina may be prepared by high temperature calcination of pseudo-boehmite (AlO(OH)).

In the compositions of the invention, the binder conveniently constitutes from 1 to 50% wt of the total content of the support and the binder, preferably 5 to 30% wt. more preferably 8 to 25% wt.

If desired a combination of two or more binders may be used, e.g. zirconia and α-alumina, for example in a weight ratio of 5:2 to 3:4 especially 9:5 to 1:1, more especially about 4:3. With this combination, the binder content may be as high as 70% wt.

The binder typically will have a mean particle size (D(v,0.5)) of less than 500 μm, preferably 2 to 200 μm, more preferably 10 to 80 μm. Mean particle size may readily be determined using a particle size analyser from Coulter.

The binder is preferably a low surface area material, e.g. having a surface area of less than 20 m²/g, more preferably less than 10 m²/g, especially less than 5 m²/g.

The binder material is preferably a hard substance, e.g. having a Mohs value of at least 3, more preferably at least 5, still more preferably at least 7, or a Knoop value of at least 130, more preferably at least 400, still more preferably at least 1000.

Desirably, the binder is a material essentially unreactive with oxygen or hydrogen at temperatures in the range 500 to 700° C.

The support in the composition of the invention preferably has a surface area of at least 20 m²/g, especially 50 to 300 m²/g, more especially 100 to 200 m²/g.

Typical metal oxides which can have such high surface areas include zirconium, hafnium, titanium, aluminium and magnesium oxides. Especially preferred are materials having a laminar structure with close packed oxygen layers and interstitial metal ions (e.g. M^{II}(M^{III})O compounds).

The support in the compositions of the invention is preferably a mixed metal oxide (e.g. an M^{II}(M^{III})O oxide, and especially preferably a Mg(Al)O oxide) or a magnesium oxide, or a mixture of metal oxides, especially one wherein at least 20% mole of the total metal content is magnesium. The support is preferably a porous material or a microcrystalline aggregate, e.g. one prepared by thermal treatment of a hydroxide or oxide-hydroxide compound, especially an anionic clay.

Thermal treatment of anionic clays such as HTC (e.g. at 300-700° C.) may be used to generate mixed metal oxides with MgO-type diffraction patterns, i.e. without separation of the M^{II} and M^{III} metals into separate phases. Thermal treatment at higher temperatures will yield spinel structures.

The combination of M^{II}(M^{III})O and such binders makes it possible to produce catalyst compositions with reduced spinel formation during their working lives. Spinel is characterised by peaks in the X-ray diffraction spectrum (using Cu K_{α} radiation) at 2 theta values of 45.5° and 65°. Thus viewed from a further aspect the invention provides a heterogeneous catalyst comprising a catalyst-impregnated Mg(Al)O support and a binder other than a magnesium or aluminium oxide which, following exposure at 700° C. to hydrogen for 30 minutes and then steam and hydrogen for 24 hours has an X-ray diffraction pattern in which the peaks at 2-theta values of 62 and 65° have a relative intensity ratio of at least 3:1, preferably at least 6:1.

The support and the binder (or their precursors) may be dry or wet-mixed to produce a composition of the invention. It is possible to precipitate a hydroxide or oxide-hydroxide precursor of the support in the presence of the binder or a binder precursor; however it is preferred to precipitate the support precursor in the absence of the binder and then to mix the support precursor and binder. Especially preferably the support precursor is precipitated in the absence of the binder, loaded with catalyst and then wet-mixed with the binder. The precursor can than be transformed into the support by thermal treatment of the support precursor/binder mixture.

The support precursor is preferably an anionic clay. Anionic clays are discussed in WO 01/12550 and have a layered structure of formula I
[M^{II}ₘM^{III}_{q}(OH)_{2m°2q}]X_{q/z}^{z-}·f H₂O (I)
where m and q are positive numbers having values such that m/q is at least 1, e.g. up to 10, more preferably up to 6, e.g. 2.5 to 6.0, especially 3 to 5; M^{II} is at least one divalent metal, preferably magnesium; M^{III} is at least one trivalent metal, preferably aluminium; X is a z-valent interlayer anion, e.g NO₃⁻, OH⁻, Cl⁻, Br⁻, I⁻, SO₄²⁻, SiO₃²⁻, CrO₄²⁻, BO₃²⁻, MnO₄⁻, HGaO₃²⁻, HVO₄²⁻, ClO₄⁻, BO₃²⁻, a pillaring anion (e.g. V₁₀O₂₈⁶⁻ or Mo₇O₂₄⁶⁻ a monocarboxylate (e.g. acetate), a dicarboxylate (e.g. oxalate), or an alkyl sulphonate (e.g. lauryl-sulphonate), preferably CO₃⁻; and f is zero or a positive number, e.g. having a value of up to 10.

One preferred class of anionic clays comprises the hydrotalcite(-like) compounds, i.e. compounds of formula II
[M^{II}ₘM^{III}_{q}(OH)ₑX_{d}^{z-}.f H₂O (II)
where M^{II}, M^{III}, X and f are as defined above, e and d are positive numbers, z is 1 or 2, and a>b. Hydrotalcite itself has the formula Mg₆ Al₂(OH)₁₆ CO₃.4H₂O. Many examples of hydrotalcite(-like) (HTC) materials are known (see for example WO 99/46039, Cavani et al. Catalysis Today 11: 173 (1991) and Besse et al. in “Anionic clays: trends in pillaring chemistry, its synthesis and microporous solids” Ed. Occelli et al., Van Nostrand Reinhold, N.Y., 1992).

Such anionic clays, in particular HTC materials, may be prepared by precipitation, e.g. by adding a base to an aqueous solution of M^{II} and M^{III} nitrates. The choice of the base and the pH control during precipitation, as well as the M^{II} and M^{III} concentrations, can be used to achieve the desired M^{II}/M^{III} ratio in the precipitated anionic clay.

While M^{II} and M^{III} in the anionic clays (and the resultant mixed metal oxides) may each comprise two or more different metals, it is preferred that each is substantially entirely (e.g. at least 90% mole, especially at least 95% mole, more especially at least 98% mole) a single metal, especially preferably Mg for M^{II} and Al for M^{III}.

Preferred identities for M^{II} include Mg, Ni and Zn while preferred identities for M^{III} include Al, Cr, Fe and Ga. Preferred M^{II}(M^{III})O supports (which may themselves provide the required catalytic activity) include Mg(Al)O, Zn(Al)O and Ni(Al)O. Mg(Al)O and Zn(Al)O may be used for example as supports for alkane dehydrogenation catalysts, while Ni(Al)O may be used as a steam reforming catalyst.

Besides M^{II}(M^{III})O compounds, other soft, high surface area compounds, e.g. γ-alumina, graphite and HTC may be used as the support in the compositions of the invention.

Besides the binder and the support or support precursor, the compositions of the invention generally also contain a catalytically active material, preferably a metal or metal compound, in particular a transition or lanthanide metal or metal compound, especially a group 4b, 5b, 6b, 7b, 8 or 4a metal or metal compound. The catalytically active material may indeed be a combination of a catalytically active metal and one or more promoters (e.g. materials which serve to reduce the acidity of the support, or to increase dispersion or improve presentation of the catalytically active metal, or to facilitate catalyst regeneration (e.g. by hydrocarbon and coke burn-off), etc.). Examples of such catalytically active metal/promoter combinations include Pt/X, Pt/X/Y and Cr/Y where X is Sn, Re or Ge and Y is Na, K, Cs, Ca, Ba or a lanthanide. Specific such combinations include Pt/Sn, Pt/Re, Pt/Ge, Pt/Sn/K, Pt/Sn/Cs, Cr/K, Cr/Na, Cr/Ca, Cr/Ba, Cr/lanthanide, etc. Where the composition is to be used as or in the production of an alkane dehydrogenation catalyst, the catalytically active material preferably comprises a group 8 and a group 4a element, especially Pt and Sn. Typically these are included as 0.1 to 2.0% wt. (relative to the total support plus binder weight) of a group 8 metal (especially a group 8 noble metal), and 0.1 to 3.0% wt of a group 4a metal. The catalyst compositions likewise may contain up to 5% wt. of a group la metal (e.g. Na), a group 2a metal or a lanthanide. For Ni and Cr systems, the metal will typically be present at levels of 3 to 70% wt, more preferably 10-50% wt, e.g. 30-40% relative to the total loaded support weight.

The catalytically active material can be incorporated into the compositions of the invention in several ways, e.g. by coprecipitation with the support or precursor, by impregnation of the support or precursor or by activation of a catalyst precursor within the support or precursor. For alkane dehydrogenation catalysts, the preferred method is to impregnate a support precursor with a catalyst precursor (e.g. a tin and platinum chloride solution), to mix with a binder and then to thermally treat the composition to generate a supported catalyst. Catalyst loading and activation are discussed further in for example WO 99/46039 and WO 94/29021 the contents of which are incorporated herein by reference.

Where the support has been calcined, e.g. where it is an M^{II}(M^{III})O produced by calcination of an HTC, catalyst loading is preferably performed before calcination and, also before calcination, the catalyst-loaded support precursor is preferably washed. This is described in Norwegian Patent Application No. 1998.6116 (and its equivalent WO 00/38832) the contents of which are hereby incorporated by reference.

The support/binder compositions of the invention, preferably catalytically active such compositions, typically should be formed into multiparticle macrostructures (e.g. spheres, pellets, etc) before subsequent use. Such forming may be carried out by conventional powder forming techniques, e.g. extrusion, tableting, pelletization, etc.

Such macrostructures preferably have maximum dimensions in the range 1 to 100 mm, especially 2 to 30 mm, and preferably have side crushing strengths, for a 5×13 mm tablet, of at least 130 N more preferably at least 200 N, e.g. 250 to 300 N (or for a 3×3 mm tablet of at least 50N, or for a 5×5 mm tablet of at least 80N), after reduction and steam treatment as discussed above.

Thermal treatment of an HTC to generate an M^{II}(M^{III})O support in the compositions of the invention is preferably effected at a temperature of 400 to 1250° C., more preferably 600 to 950° C., especially 750 to 850° C., and preferably for a period of 1 to 30 hours, more preferably 5 to 24 hours, especially 12 to 18 hours. Such thermal treatment (also known as calcination) is conveniently effected in air. Before calcination, the precursor composition should be dried, e.g. by heating to 90 to 150° C., especially about 100° C., for 1 to 48 hours, preferably 10 to 20 hours. If continuous driers, e.g. rotary driers or conveyor belt driers, are used lower drying and calcination times will normally be applied, e.g. 0.5 to 10 hours, preferably 0.5 to 5 hours.

In the compositions of the invention, the support is preferably a metal oxide and the particulate binder is preferably a metal or semi-metal compound the metal or semi-metal of which is of different valency and/or is in a different row of the periodic table to the metal of the metal oxide support.

By a semi-metal is meant an element which occurs between the metals and non-metals in the periodic table, e.g. silicon (see Chambers Dictionary of Science and Technology, Chambers Harrap, Edinburgh, UK, 1999, page 1288).

The invention also encompasses the use of the heterogeneous catalyst compositions in catalysed reactions. Thus viewed from a further aspect the invention provides a process comprising a heterogeneously catalysed chemical reaction, characterised in that said reaction is effected in the presence of a catalyst composition according to the invention. Viewed from a still further aspect the invention provides the use of a heterogeneous catalyst composition according to the invention as a catalyst in a chemical reaction.

In a preferred embodiment, the chemical reaction is an alkane (e.g. C₁₋₆ alkane) dehydrogenation, especially ethane, propane or butane dehydrogenation, particularly propane dehydrogenation (PDH). For this purpose, the support is preferably Pt/Sn/Mg(Al)O and the binder is preferably α-alumina or zirconia. PDH may be carried out as described in WO94/29021 the contents of which are hereby incorporated by reference.

Viewed from still further aspects the invention provides the use of a binder selected from particulate zirconia, silicon carbide, boron carbide, metal carbides and alpha and theta alumina for the manufacture of compositions, e.g. catalyst or catalyst carrier compositions, comprising a compacted mixture of said particulate binder and a higher surface area particulate support material, e.g. an M^{II}(M^{III})O or an anionic clay, as well as such compacted compositions.

We believe the concept of achieving improved strength in an extruded or compacted particulate composition comprising a carrier and a binder by the use of a binder that is harder than the carrier is novel and generally applicable. Thus viewed from a further aspect the invention provides a method of producing a formed composite material (e.g. by compacting or extruding) from a particulate mixture of a particulate binder and a particulate carrier, e.g. a binder having a lower surface area per unit weight than the carrier, said method comprising using as said binder a material which is harder than said carrier, e.g. by at least 3 points, more preferably at least 5 points on the Mohs scale, or by at least 500, more preferably at least 800 on the Knoop scale. Suitable binders include in particular alpha-alumina, carbides and zirconia. Suitable carriers (which may be catalyst impregnated) include HTC, M^{II}(M^{III})O and gamma alumina.

The invention will now be illustrated further with reference to the following non-limiting Examples and the accompanying drawings in which:

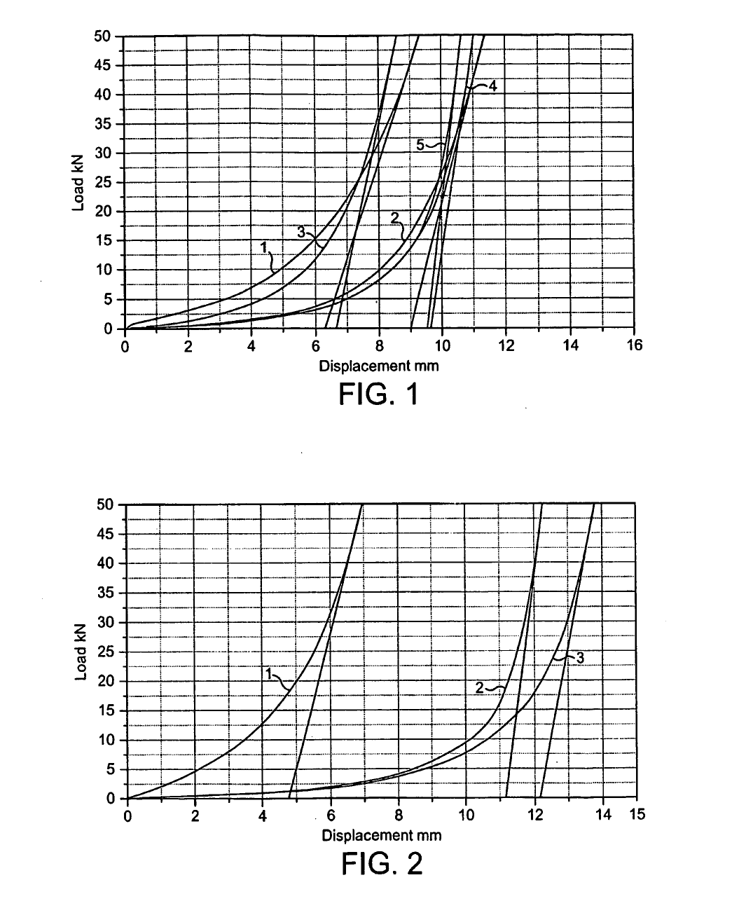

FIG. 1 is a plot of displacement against load for five specimens (1) α-Al₂O₃, (2) γ-Al₂O₃, (3) ZrO₂, (4) calcined hydrotalcite and (5) hydrotalcite;

FIG. 2 is a plot of displacement against load for three specimens (1) silicon carbide, (2) hydrotalcite and (3) calcined hydrotalcite; and

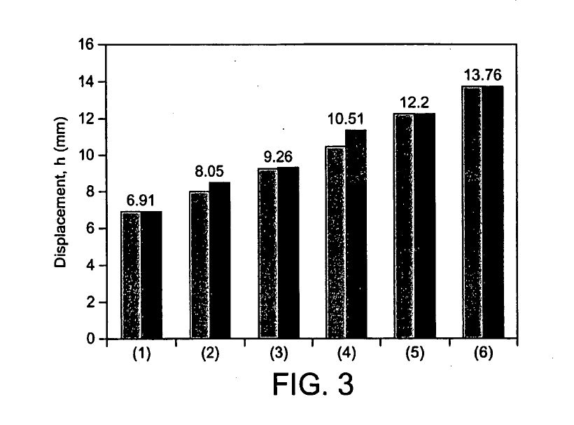

FIG. 3 is a bar chart showing corrected (left hand of each bar) and measured (right hand of each bar) displacements under a loading of 50 kN for six specimens (1) silicon carbide, (2) ZrO₂, (3) α-Al₂O₃, (4) γ-Al₂O₃, (5) hydrotalcite and (6) calcined hydrotalcite.

### GENERAL

X-Ray powder diffraction was performed using Cu K_{α} radiation with a Siemens D5000 2-theta diffractometer.

The surface area was measured by nitrogen adsorption using the BET-method. The measurements were carried out using a Quantachrome monosorb apparatus. Side crushing strength measurements (SCS) were performed on a Schenck Krebel RM 100 universal material test apparatus.

All samples were pelletised using an IR tablet press. Pellets with 13 mm diameter were prepared using approx. 1 g powder and applying a pressure of 120 kg/cm², yielding a pellet height of 5 mm.

Some of the samples were exposed to cyclic propane dehydrogenation (PDH)-testing. One test cycle comprises: reduction of the catalyst; exposure to PDH reaction conditions; and stepwise regeneration. The feed conditions for one cycle are given in Table 1. Two samples were exposed to steaming at 700° C. for 24 hours. The feed conditions were 8.3 g/h steam, 13 ml/h H₂. These steam tests were carried out in order to investigate the samples' resistance to spinel formation.

TABLE 1
PDH test conditions.

| | Step 1 | Step 2 | Step 3 | Step 4 | Step 5 | Step 6 |
|---|---|---|---|---|---|---|
| | Reduction | PDH | 1% O₂/N₂ | 5% O₂/N₂ | 10% O₂/N₂ | 20% O₂/N₂ |
| N₂ (ml/min) | 241 | | 277 | 218 | 146 | |
| Air (ml/min) | | | 14.3 | 73 | 146 | 291 |
| Propane (ml/min) | | 92.9 | | | | |
| H₂O (g/h) | | 8.3 | | | | |
| H₂ (ml/min) | 50 | 13.1 | | | | |
| Duration (min) | 30 | 1200 | 60 | 60 | 60 | 60 |

The six catalyst samples given in Table 2 were prepared. They contain 0.5 wt % platinum and 1.2 wt % tin supported on a calcined hydrotalcite (HTC). All but one catalyst contain a binder material. In addition four γ-alumina based samples without the active metals Pt and Sn were prepared. They contain a binder added by three different techniques. They are listed in Table 3.

TABLE 2
List of catalysts prepared

| EXAMPLE | CATALYSTS |
|---|---|
| 1 | 0.5Pt, 1.2 Sn/HTC + 10% boehmite |
| 2 | 0.5Pt, 1.2 Sn/HTC + 10% α-alumina |
| 3 | 0.5Pt, 1.2 Sn/HTC + 10% zirconia |
| 4 | 0.5Pt, 1.2 Sn/HTC, no binder |
| 5 | 0.5Pt, 1.2 Sn/HTC + 20% boehmite |
| 6 | 0.5Pt, 1.2 Sn/HTC + 20% zirconia |

TABLE 3
Samples of type γ-alumina + binder.

| | Mixing |
|---|---|
| Sample | procedure |
| γ-alumina | |
| γ-alumina + 10 wt % zirconia | Dry mixing |
| γ-alumina + 10 wt % zirconia | Wet mixing |
| γ-alumina + 10 wt % Mg(Al)O | Precipitation |

### EXAMPLE 1 (COMPARATIVE)

### Preparation of 0.5Pt, 1.2Sn/HTC+10% boebmite

Pseudo-boehmit (AlO(OH), Vista B, 3.19 g, 0.053 mol) was suspended in distilled water (200 ml) and heated to 60° C. Two solutions were prepared; one with Mg(NO₃)₂.6H₂O (233 g, 0.91 mol) and Al(NO₃)₃.9H₂O (34.0 g, 0.09 mol) in distilled water (900 ml), and another with Na₂CO₃ (4.8 g, 0.045 mol) and NaOH (45.2 g, 1.1 mol) in distilled water (900 ml). The two solutions were dripped into the aqueous suspension of pseudo-boehmite (duration 45 mm). The pH in the precipitate solution was 9.5-10. The precipitate was filtered, then washed to neutrality and left overnight.

SnCl₂2H₂O (0.4804 g, 2.13 mmol) was dissolved in conc. HCl (10 ml). H₂PtCl₆. 6H₂O (0.157 g, 0.38 mmol) was dissolved in distilled water (50 ml), and the tin chloride solution added. The resulting solution had a red colour.

The Mg—Al precipitate was suspended in distilled water (400 ml) and the Pt—Sn solution dripped into the suspension, which had a neutral pH value. The suspension was stirred for 45 min, then filtered and washed twice with distilled water. The product was then dried at 100° C./16 h and calcined 800° C./15 hours.

### EXAMPLE 2

### Preparation of 0.5Pt, 1.2Sn/HTC+10% α-alumina

α-alumina (2.7 g, 0.031 mol, prepared by calcination of AlO(OH), Vista B, for 12 hrs. at 1250° C.) was suspended in distilled water (200 ml) and heated to 60° C.

Two solutions were prepared; one with Mg(NO₃)₂.6H₂O (233 g, 0.91 mol) and Al(NO₃)₃.9H₂O (34.0 g, 0.09 mol) in distilled water (900 ml), and another with Na₂CO₃ (4.8 g, 0.045 mol) and NaOH (45.2 g, 1.1 mol) in distilled water (900 ml). The two solutions were dripped into the aqueous suspension of α-alumina (duration 45 mm). The pH in the precipitate solution was 9.5-10. The precipitate was filtered, then washed to neutrality and left overnight.

SnCl₂2H₂O (0.4804 g, 2.13 mmol) was dissolved in conc. HCl (10 ml). H₂PtCl₆6H₂O (0.157 g, 0.38 mmol) was dissolved in distilled water (50 ml), and the tin chloride solution added. The resulting solution had a red colour.

The Mg—Al precipitate was suspended in distilled water (400 ml) and the Pt—Sn solution dripped into the suspension, which had a neutral pH value. The suspension was stirred for 45 min, then filtered and washed twice with distilled water. The product was then dried at 100° C./16 h and calcined 800° C./15 hours.

### EXAMPLE 3

### Preparation of 0.5Pt, 1.2Sn/HTC+10% zirconia

Zirconia (2.7 g, 0.022 mol, prepared by calcination of Zr(OH)₄ for 6 hrs. at 350° C.) was suspended in distilled water (200 ml) and heated to 60° C. Two solutions were prepared; one with Mg(NO₃)₂.6H₂O (233 g, 0.91 mol) and Al(NO₃)₃.9H₂O (34.0 g, 0.09 mol) in distilled water (900 ml), and another with Na₂CO₃ (4.8 g, 0.045 mol) and NaOH (45.2 g, 1.1 mol) in distilled water (900 ml). The two solutions were dripped into the aqueous suspension of zirconia (duration 45 mm). The pH in the precipitate solution was 9.5-10. The precipitate was filtered, then washed to neutrality and left overnight.

SnCl₂2H₂O (0.4804 g, 2.13 mmol) was dissolved in conc. HCl (10 ml). H₂PtCl₆6H₂O (0.157 g, 0.38 mmol) was dissolved in distilled water (50 ml), and the tin chloride solution added. The resulting solution had a red colour.

The Mg—Al precipitate was suspended in distilled water (400 ml) and the Pt—Sn solution dripped into the suspension, which had a neutral pH value. The suspension was stirred for 45 min, then filtered and washed twice with distilled water. The product was then dried at 100° C./16 h and calcined 800° C./15 hours.

### EXAMPLE 4 (COMPARATIVE)

### Preparation of 0.5Pt, i.2Sn/HTC, No Binder

Two solutions were prepared; one with Mg(No₃)₂.6H₂O (233 g, 0.91 mol) and Al (NO₃)₃.9H₂O (34.0 g, 0.09 mol) in distilled water (900 ml), and another with Na₂CO₃ (4.8 g, 0.045 mol) and NaOH (45.2 g, 1.1 mol) in distilled water (900 ml). The two solutions were dripped into water (duration 45 mm). The pH in the precipitate solution was 9.5-10. The precipitate was filtered, then washed to neutrality and left overnight.

SnCl₂2H₂O (0.4804 g, 2.13 mmol) was dissolved in conc. HCl (10 ml). H₂PtCl₆6H₂O (0.157 g, 0.38 mmol) was dissolved in distilled water (50 ml), and the tin chloride solution added. The resulting solution had a red colour.

The Mg—Al precipitate was suspended in distilled water (400 ml) and the Pt—Sn solution dripped into the suspension, which had a neutral pH value. The suspension was stirred for 45 mmin, then filtered and washed twice with distilled water. The product was then dried at 100° C./16 h and calcined 800° C./15 hours.

### EXAMPLE 5 (COMPARATIVE)

### Preparation of 0.5Pt, 1.2Sn/HTC+20% boehmite

The catalyst was prepared analogously to that of Example 1 but using double the amount of boehmite.

### EXAMPLE 6

### Preparation of 0.5Pt, 1.2Sn/HTC+20% zirconia

The catalyst was prepared analogously to that of Example 3 but using double the amount of zirconia and in a double sized batch.

### EXAMPLE 7

### Preparation of Samples of Type γ-alumina+Binder

Different γ-alumina based samples were prepared using a precipitation method. The pure γ-alumina was prepared as follows: AlCl₃ (61.5 g) was dissolved in 150 ml H₂O. NH₃ solution (25% in water) was added under stirring until a pH of 9-9.5 was reached. While the pH increased during NH₃ addition, the suspension became highly viscous. Finally, manual stirring was required. A total volume of 55 ml NH₃ solution was required to reach the final pH value. The product was washed first in aqueous 1% NH₃ solution and then with water. The product was then dried overnight at 100° C. and finally calcined at 650° C. for 15 hours. Two γ-alumina-based samples containing zirconia as a binder were prepared. A further sample was prepared using a hard M^{II}(M^{III})O prepared by high temperature calcination of HTC. The γ-alumina-based samples are listed in Table 3. In two cases, the binder material was added to the γ-alumina after precipitation. In one case the binder was added to the calcined alumina (dry mixing), and in another case it was added after precipitation but before the drying and calcination steps (wet mixing). In a third case the γ-alumina was precipitated onto the binder.

### EXAMPLE 8

### Propane Dehydrogenation (PDH) Tests

The materials prepared according to Examples 1 to 4 were subjected to testing under PDH conditions at 600° C., at atmospheric pressure in a quartz reactor with internal diameter 23 mm. The reactor was heated to 600° C. in a N₂ flow, then subjected to reduction, PDH and regeneration test cycles according to Table 1. The GHSV (Gas Hourly Space Velocity) was 1000/hour, based on propane. The test was stopped after 6 test cycles with regeneration, and the catalyst cooled to room temperature in a N₂ flow.

### EXAMPLE 9

### Steaming Tests

The materials prepared according to Examples 5 and 6 (batch II only) were subjected to steaming at 700° C. in a quartz reactor with an inner diameter of 23 mm. The reactor was heated to 700° C. in a N₂ flow, then subjected to a reduction according to the first column in Table 1. Then the sample was exposed to steam (8.3 g/h) and hydrogen (13 ml/min) for 24 hours at the same temperature.

### EXAMPLE 10

### Strength Data

The side crushing strength (SCS) was measured for the materials prepared according to Examples 1 to 6 and the results are set out in Table 4. The measurements were carried out both on the fresh and tested catalysts. Samples prepared according to Examples 1 to 4 were exposed to cyclic PDH-testing (Example 8), whereas the samples prepared according to Examples 5 and 6 were exposed to steaming (Example 9).

TABLE 4
Mechanical strength measured before and after
PDH-testing according to Example 8 (for Examples 1-4)
and after steaming according to Example 9 (for Examples
5 and 6).

SCS (N)

| Example | Binder | before | after |
|---|---|---|---|
| 1 | 10 wt % boehmite | 206 | 249 |
| 2 | 10 wt % α-alumina | 173 | 256 |
| 3 | 10 wt % zirconia | 137 | 225 |
| 4 | None | 100 | 120 |
| 5 | 20 wt % boehmite | 225 | 161 |
| 6 | 20 wt % zirconia | 138 | 267 |

Although the mechanical strength in terms of the SCS-values shows some differences for the samples with 10 wt % binder, they all lie above the value for the sample without binder. Furthermore, after PDH-testing all samples with 10 wt % binder show essentially the same mechanical strength. The fresh catalyst containing 20 wt % zirconia has significantly lower mechanical strength than the sample with 20 wt % boehmite. After steaming the catalyst with 20 wt % zirconia has a significantly higher mechanical strength than the boehmite-containing catalyst. Hence, the use of zirconia and α-alumina as binders yields pellets with comparable (10 wt % binder) or even better (20 wt % binder) mechanical strength after PDH-testing/steaming compared with boehmite as a binder.

This is an interesting result since materials like zirconia and α-alumina constitute inert, low-surface-area materials and would normally not be an obvious choice as binders. However, in the present case these materials show nearly equal mechanical strength after use than the boehmite-containing sample. This is an interesting finding since inert materials might have some advantages over boehmite in terms of the thermal- and steam stability of the catalysts. This is important at PDH conditions with a typical temperature range between 550 and 750° C. and a steam/propane mole ratio between 1:1 and 5:1.

The mechanical strength of the fresh γ-alumina based samples is given iii Table 5. The values are considerably lower than for the hydrotalcite based catalysts, however a binder effect is clearly seen.

TABLE 5
Mechanical strength of the fresh samples of
type γ-alumina + binder.

| | Mixing | |
|---|---|---|
| Sample | procedure | SCS (N) |
| γ-alumina | | 31 |
| γ-alumina + 10 wt % zirconia | Dry mixing | 42 |
| γ-alumina + 10 wt % zirconia | Wet mixing | 41 |
| γ-alumina + 10 wt % Mg(Al)O* | Precipitation | 43 |

*Hard binder, low surface area (5 m²/g), produced by high temperature calcination (1250° C.) of HTC

### EXAMPLE 11

### Spinel Formation

Samples of the products of Examples 5 and 6 were exposed to steaming at 700° C. FIG. 1 of the accompanying drawings shows X-ray diffraction patterns of the two samples before and after steaming. Additionally X-ray diffraction patterns of pure zirconia, calcined at 800° C. were collected. This was done in order to identify those peaks in the zirconia containing samples which are due to zirconia. The two peaks at 2θ-values of 44.5° and 65° were taken as an indication for the extent of formation of spinel. Unlike other spinel-peaks these two signals do not overlap with the Mg(Al)O peaks or the strongest peaks of ZrO₂. Boehmite is not visible in the spectra and does not cause any problems in this respect. The fresh, boehmite-containing catalyst contains small amounts of spinel as indicated by the small spinel peaks. This spinel forms during the calcination of the catalyst. The zirconia containing catalyst shows no detectable amounts of spinel before steaming. After steaming the boehmite-containing catalyst shows a significant increase in the intensity of the two spinel peaks. On the other hand the zirconia-containing catalyst shows much weaker spinel signals after steaming.

### EXAMPLE 12

### Compressibility

A metal mould with diameter 13 mm (area 1.33 cm²) was used to press samples of zirconia, alpha alumina, HTC, calcined HTC (800° C./15 hours), gamma alumina, and silicon carbide sieved to give particles in the size range 50-90 μm. Stearic acid in ethanol was used as a lubricant. The mould material (Avest 248SV) could be loaded up to a maximum of 55 kN/cm³. The maximum load used in this test was 50 kN. The different powders were tapped on the bench in a 10 ml volumetric cylinder for about 5 min until a volume of 2.45 ml was achieved. This volume was then transferred to the mould and gently pressed to achieve the same height for each sample (ca. 18.4 mm), i.e. to remove air. The five different binder materials were then uniaxially pressed in an Instron model 1185 automatic materials tester at a constant rate of 2 mm/min up to a maximum of 50 kN.

The results are shown graphically in FIGS. 1 and 2. For FIG. 1, the samples were (1) alpha alumina, (2) gamma-alumina, (3) zirconia, (4) calcined HTC, and (5) HTC. For FIG. 2, the samples were (1) silicon carbide, (2) HTC, and (3) calcined HTC. The measured value of displacement was corrected by editing the raw data: thus the displacement value registered before a load of 0.4 kN was reached was subtracted from the displacement measured to give a common origin. In FIG. 3 are shown the corrected and uncorrected displacements for the six materials at a load of 50 kN.

1. A formed heterogeneous catalyst composition comprising a particulate M^{II}(M^{III})O (wherein M^{II} and M^{III} are divalent and trivalent metals respectively) catalyst support and a particulate binder wherein the surface area per unit weight of the support is greater than that of said binder and wherein the compressability of said binder is less than that of said support, with the provisos that where said support carries a catalytically active metal and is the product of calcination of an HTC in the presence of a magnesium or aluminium oxide then said catalytically active metal is loaded onto said support before said support is contacted with said binder and that where said support is M^{II}(M^{III})O wherein the divalent and trivalent metals are nickel and aluminium and which is not impregnated with a catalytically active metal then the binder is other than alumina or zirconia.

2. A particulate heterogeneous catalyst composition comprising a particulate, catalyst-carrying, M^{II}(M^{III})O support and a particulate binder wherein the surface area per unit weight of the support is greater than that of said binder and wherein the compressability of said binder is less than that of said support, with the provisos that where said support carries a catalytically active metal and is the product of calcination of a hydrotalcite(-like) clay (HTC) in the presence of a magnesium or aluminium oxide then said catalytically active metal is loaded onto said support before said support is contacted with said binder and that where said support is an M^{II}(M^{III})O wherein the divalent and trivalent metals are nickel and aluminium and which is not impregnated with a catalytically active metal then the binder is other than alumina or zirconia

3. A heterogeneous catalyst composition comprising a particulate, catalyst-impregnated HTC support and a particulate binder or binder precursor, which precursor if present is a material transformable into a binder by thermal treatment under conditions which transform said HTC support into a M^{II}(M^{III})O support, said composition being transformable by thermal treatment into a particulate heterogeneous catalyst composition comprising a particulate, catalyst-carrying, M^{II}(M^{III})O support and a particulate binder wherein the surface area per unit weight of the support is greater than that of said binder and wherein the compressability of said binder is less than that of said support, with the proviso that where said binder or binder precursor is a magnesium or aluminium oxide then said HTC support is loaded with catalyst before being contacted with said binder or binder precursor.

4. A formed heterogeneous catalyst composition comprising a particulate catalytically active substance and a particulate binder wherein the weight ratio of said substance to said binder is in the range 99:1 to 50:50, wherein the surface area per unit weight of the support is greater than t at of said binder and wherein the compressability of said binder is less than that of said support, with the provisos that where said substance is an HTC or M^{II}(M^{III})O wherein the divalent and trivalent metals are magnesium and aluminium and said binder is a magnesium or aluminium oxide then said substance is loaded with a catalytically active metal before being contacted with said binder, and that where said support is an HTC or M^{II}(M^{III})O wherein the divalent and trivalent metals are nickel and aluminium and which is not impregnated with a catalytically active metal then the binder is other than alumina or zirconia.

5. A catalyst composition as claimed in claim 4 wherein said catalytically active substance is a catalyst carrying support material.

6. A catalyst as claimed in claim 5 wherein said support material is selected from M^{II}(M^{III})O compounds, graphite, γ-alumina and hydrotalcite(-like) clays.

7. A catalyst composition as claimed in any one of claims 1 to 6 wherein said binder is selected from metal oxides, silica, boron nitride and silicon carbide.

8. A catalyst composition as claimed in any one of claims 1 to 7 wherein said binder comprises zirconia.

9. A catalyst composition as claimed in any one of claims 1 to 7 wherein said binder comprises alpha-alumina.

10. A catalyst composition as claimed in any one of claims 1 to 9 having a surface area of at least 20 m²/g.

11. A catalyst composition as claimed in any one of claims 1 to 10 wherein said binder is present at 5 to 30% wt of the total composition weight.

12. A catalyst composition as claimed in any one of claims 1 to 11 wherein said Finder has a surface area of less than 10 m²/g.

13. A process for the preparation of a heterogeneous catalyst composition according to any one of claims 1 to 12, which process comprises:
i) loading a particulate HTC support with a catalytically active metal.
ii) before, during or preferably after step (i), forming a mixture of said HTC support and a particulate binder or binder precursor;
iii) thermally treating said mixture whereby to transform said HTC support into an M^{II}(M^{III})O support and, where a binder precursor is present, to transform said binder precursor into a particulate binder; and, optionally;
iv) forming the thermally treated mixture into a formed heterogeneous catalyst composition formed heterogeneous catalyst composition comprising a particulate catalytically active substance and a particulate binder wherein the weight ratio of said substance to said binder is in the range 99:1 to 50:50, wherein the surface area per unit weight of the support is greater than that of said binder and wherein the crushing strength of said binder is greater than that of said support, with the provisos that where said substance is an HTC or M^{II}(M^{III})O wherein the divalent and trivalent metals are magnesium and aluminium and said binder is a magnesium or aluminium oxide then said substance is loaded with a catalytically active metal before being contacted with said binder, and that where said support is an HTC or M^{II}(M^{III})O wherein the divalent and trivalent metals are nickel and aluminium and which is not impregnated with a catalytically active metal then the binder is other than alumina or zirconia.

14. A process comprising a heterogeneously catalysed chemical reaction, characterised in that said reaction is effected in the presence of a catalyst composition according to any one of claims 1 to 12.

15. A process as claimed in claim 14 wherein said reaction is an alkane dehydrogenation.

16. The use of a heterogeneous catalyst composition according to any one of claims 1 to 12 as a catalyst in a chemical reaction.

17. The use of a binder selected from particulate zirconia, silicon carbide, boron carbide, metal carbides and alpha and theta alumina for the manufacture of compositions comprising a compacted mixture of said particulate binder and a higher surface area particulate support material.

18. Use as claimed in claim 17 wherein said support material is an M^{II}(M^{III})O or an anionic clay.

19. A method of producing a formed composite material from a particulate mixture of a particulate binder and a particulate carrier, said method comprising using as said binder a material which is harder than said carrier.
